(19) United States
(12) Patent Application Publication
(10) Pub. No.: US 2004/0022011 A1
(43) Pub. Date: Feb. 5, 2004

(54) Chip-type solid electrolytic capacitor

(75) Inventors: Keigo Shimoda, Sannohe-gun (JP); Masaaki Kudo, Sannohe-gun (JP)

Correspondence Address: KODA & ANDROLIA, 2029 CENTURY PARK EAST, SUITE 1430, LOS ANGELES, CA, 90067-3024, US

(73) Assignee: Fujitsu Media Devices Limited

(21) Appl. No.: 10/613,250

(22) Filed: Jul. 3, 2003

(30) Foreign Application Priority Data
Jul. 30, 2002 (JP) 2002-220577

(51) Int. Cl. H01G 9/00

(52) U.S. Cl. 361/523

(57) ABSTRACT

A square box-shape chip-type solid electrolytic capacitor has a capacitor element provided with an anodic lead terminal and a cathodic lead terminal. Respective terminal has a protruded portion bent so as to run along or on a wall face of a transfer-molded synthetic resin body or sheath. The protruded portions of the anodic lead terminal and the cathodic lead terminal, which portions protruding from the synthetic resin body or sheath, fail to place themselves on the same face. The protruded portions have a difference to each other in height. The parts of the protruded portions run in vertical directions and the lengths of the vertical parts protruded from the synthetic resin are differed from each other.

### BACKGROUND OF THE INVENTION

1. Field of the Invention

The present invention relates to a square box-shape chip-type solid electrolytic capacitor to be mounted on a printed substrate.

In particular, the present invention relates to a lead-out structure of a lead terminal of a square box-shape chip-type solid electrolytic capacitor molded on an outside of a molded body made of an insulating synthetic resin.

2. Description of the Prior art

A structure of a lead terminal of a conventional chip-type solid electrolytic capacitor of a square box-shape will be explained with reference to FIG. 1.

As shown in FIG. 1, an anodic lead 2 is led out of a capacitor element land an anodic lead terminal 3 is connected to the anodic lead 2 by means of a resistance welding method.

Also, as shown in FIG. 1, a cathodic layer 4 is formed on an outside surface of the capacitor element 1 and a cathodic lead terminal 5 in a shape of a crank is connected to the cathodic layer 4 by means of electrical conductive adhesive agent or solder 6.

The anodic lead terminal 3, a bent portion 5c in a shape of crank, which portion is a part of the cathodic lead terminal 5, and the capacitor element 1 are formed by means of a transfer molding method using synthetic resin in a sheath 7. The anodic lead terminal 3 is bent and runs along a sidewall 7a and a bottom face 7c of the transfer-molded synthetic resin body or sheath 7. A front end portion 3a of the anodic lead terminal 3 is bent and runs along the bottom face 7c of the transfer-molded synthetic resin body or sheath 7.

It is noted that the cathodic lead terminal 5 is bent and runs along a side wall 7b and the bottom face 7c of the transfer-molded synthetic resin body or sheath 7. That is, an end portion 5a of the cathodic lead terminal 5 runs along the bottom face 7c of the body or sheath 7.

In accordance with the structure of the present invention after the anodic lead terminal 3 and the cathodic lead terminal 5 are bent as shown in FIG. 1, a shoulder or a protruded portion 3b of the anodic lead terminal 3, which portion projecting from the transfer-molded synthetic resin body or sheath 7, and a shoulder or protruded portion 5b of the cathodic lead terminal 5, which portion projecting from the transfer-molded synthetic resin body or sheath 7, respectively are formed and protruded from the transfer-molded synthetic resin body or sheath 7 along a kine or a flat face d-d′ of a parting line 8. As a result. the bent portion 5c of a crank shape of the cathodic lead terminal 5 is placed within a body of the transfer-molded synthetic resin sheath 7.

By the way, it is necessary disadvantageously to consider, when the square box-shape chip-type solid electrolytic capacitors of the prior art are manufactured, bending margins or allowances of the material of the lead terminals, connecting margins or allowances between the lead terminals and the capacitor elements, and a thickness of the transfer-molded synthetic resin body or sheath 7 surrounding or covering the capacitor element or the lead terminals. In addition, it is difficult to enlarge a capacitor element in the small-size square box-shape chip-type solid electrolytic capacitor. So it is a problem that a volume efficiency of the conventional small-size chip-type solid electrolytic capacitors is bad.

Therefore, several methods for improving such volume efficiency have been proposed in the engineering field.

For example, according to one of such conventional methods improving a volume efficiency of the small-size chip-type solid electrolytic capacitors, an insulated substrate is employed as an outside electrode terminal, a plating treatment is applied onto a portion to be used as an electrode of the insulated substrate, capacitor elements are arranged on the insulated substrate at a pattern of several rows and mounted on the insulated substrate, these capacitor elements arranged in several rows are molded together and covered with synthetic resin, and last these capacitor elements are cut obtaining respective capacitor element.

There are several problems prohibiting the conventional method from improving a volume efficiency: an insulated substrate is used as an outside electrode terminal, which substrates aren't employed in the conventional square box-shape chip-type solid electrolytic capacitor, and several capacitor elements are mounted and covered with a molded synthetic resin at a same time and all together, so that the conventional capacitor element mounting machine and molding dies cannot be used.

As a result, the cost of designing of the outside electrode terminals and investment in capacitor element mounting machines and dies of various parts of the square box-shape chip-type solid electrolyte capacitor rises.

In addition, in a structure of the chip-type solid electrolyte capacitor of the prior art, the end portion 3a and another end portion 5a respectively of anodic lead terminal 3 and cathodic lead terminal 5, which end portions run along the sidewalls 7a and 7b of the transfer-molded synthetic resin body or sheath 7, are identical with each other in length and symmetry in shape.

Accordingly, it is difficult to distinguish poles of anode and cathode from each other when a small-size chip-type solid electrolytic capacitor is used.

### SUMMARY OF THE INVENTION

The present invention can be completed after various problems above are considered and much study and many tests are carried out solving the problems.

Accordingly, one of the objects of the present invention is to provide a novel square box-shape chip-type solid electrolytic capacitor having an improved volume efficiency and a static electrical capacitance which is large relative to its outside size. Such improved volume efficiency and large static electrical capacitance are obtained by only a change of size and a position of bending work of partly a belt like lead frame and resultant change of designing of mold dies without substantial change of the working steps and members to be employed in the prior art.

Another object of the present invention is to provide a square box-shape chip-type solid electrolytic capacitor having a cathode and an anode, which are easy to be distinguished one pole from another pole.

In the structure of the square box-shape chip-type solid electrolytic capacitor according to the present invention having extended portions of the lead terminals of the anode and cathode, respective pole being connected to the capacitor element, and which extended portions being bent and run along the sidewalls of the transfer-molded synthetic resin body or sheath; the bent portion of the cathodic lead terminal for leading out the cathodic lead terminal is placed on and protrudes from the outside of the transfer-molded synthetic resin body or sheath.

According to the prior art, the anodic lead terminal and the cathodic lead terminal are led out in the same face extending through the transfer-molded synthetic resin body or sheath. According to the present invention, the bent portion of the cathodic lead terminal is placed on the outside of the transfer-molded synthetic resin body or sheath, so that the bent portion in the transfer-molded synthetic resin body or sheath is removed and the upper faces of the led out protruded portions of the anodic lead terminal and the cathdic lead terminal fail to place in the same face resulting in a difference in height between the protruded portion.

As a result, when the transfer-molded synthetic resin body or sheath is machined or molded, the bent portion of the cathodic lead terminal is formed and placed outside of the transfer-molded synthetic resin body or sheath. A volume of the part within the transfer-molded synthetic resin body or sheath, which part corresponding to the bent portion of the cathodic lead terminal, can be replaced usefully with a part of the capacitor element.

In other word, it is not necessary to take into consideration the thickness of the molded synthetic resin covering the cathodic lead terminal and a margin for bending the cathodic lead terminal, so that it is possible to contain a capacitor element of a size enlarged correspondingly to the removed bending margin and the thin cover in the transfer-molded synthetic resin body or sheath.

Also, the lengths of the anodic lead terminal and of cathodic lead terminal are differed from each other after they are bent and placed on and along the sidewalls of the transfer-molded synthetic resin body or sheath.

As a result, it becomes easy to distinguish one of poles of anode and cathode of the lead terminal from another one.

### BRIEF DESCRIPTION OF THE DRAWINGS

FIG. 1 is a sectional view of the conventional square box-shape chip-type solid electrolytic capacitor.

FIG. 2 is a sectional view similar to FIG. 1 of an embodiment of the square box-shape chip-type solid electrolytic capacitor according to the present invention.

FIG. 3 is a partly removed sectional view showing a lead frame after the synthetic resin body or sheath is transfer-molded according to the embodiment of the square box-shape chip-type solid electrolytic capacitor of the present invention.

### DESCRIPTION OF THE PREFERRED EMBODIMENT

The square box-shape chip-type solid electrolytic capacitor of the present invention will be described in detail with reference to the accompanying drawings.

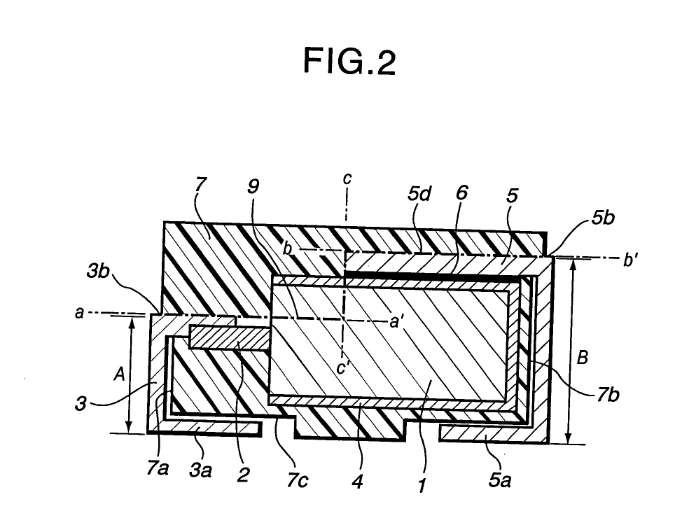

As shown in FIG. 2, an anodic lead 2 led out from a capacitor element 1 of the square box-shape chip-type solid electrolytic capacitor according to the present invention is connected to an anodic lead terminal 3 of a lead frame made of a metal plate by means of resistance welding.

A cathodic layer 4 formed in a surrounding of the capacitor element 1 is connected to a cathodic lead terminal 5 of the lead frame, which terminal confronting to the anodic lead terminal 3, by means of conductive adhesive or solder 6.

A capacitor element 1 and parts of the anodic lead terminal 3 and the cathodic lead terminal 5 are sealed by a transfer-molded synthetic resin body or sheath 7 covering them.

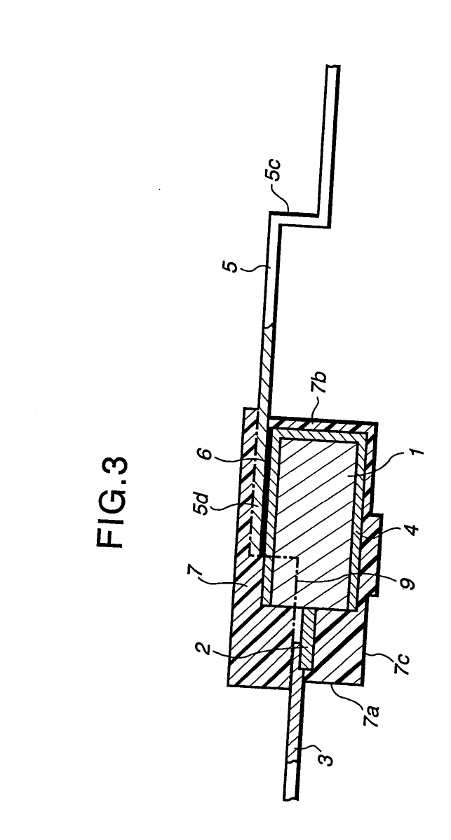

FIG. 3 shows lead frame of the anodic lead terminal 3 and the cathodic lead terminal 5 after the transfer-molded synthetic resin body or sheath 7 molded to cover these terminals 3 and 5.

As shown in FIG. 3, the part or crank shape bent portion 5c of the cathodic lead terminal 5 is placed outside of the transfer-molded synthetic resin body or sheath 7.

As shown in FIG. 3, a protruded portion 3b of the anodic lead terminal 3, which portion protruding from the sidewall 7a of the transfer-molded synthetic resin body or sheath 7, is placed on or led out from a plane face a-a′ horizontally.

Apparently, the plane face a-a′ is placed above an upper face of the anodic lead 2 or a horizontal connecting face of the anodic lead 2 with the anodic lead terminal 3.

While a plane of the protruded portion 5a of the cathodic lead terminal 5, which portion is placed out of another sidewall 7a of the transfer-molded synthetic resin body or sheath 7 protrudes along a plane b-b′ substantially identical with a plane of the connection portion 5a between the transfer-molded synthetic resin body or sheath 7 and the cathodic lead terminal 5. It is apparent that the plane b-b′ has a different height or level measured from the plane a-a′.

In another words, a led out plane of the anodic lead terminal 3 and another lead out plane of the cathodic lead terminal 5 have different heights. In short, a difference in height of them equals to another difference in height of the plane a-a′ and the plane b-b′. A molding die used for manufacturing the transfer-molded synthetic resin body or sheath 7 of the square box-shape chip-type solid electrolytic capacitor is composed of an upper die part and a lower die part. These die parts are separated by a parting line 9 consisting of three planes of a-a′, b-b′ and c-c′.

A portion A of the anodic lead terminal 3 led out of the molded capacitor element 1 is bent and placed on or along the sidewall 7a of the transfer-molded synthetic resin body or sheath 7. An end portion 3a of the anodic lead terminal 3 is bent and placed along or on the bottom face 7a of the transfer-molded synthetic resin body or sheath 7.

Additionally, a portion B of the cathodic lead terminal 5 led out of the molded capacitor element 1, which portion B being longer than the portion A of the anodic lead terminal 3, is bent and placed along and on the sidewall 7a of the transfer-molded synthetic resin body or sheath 7. An end portion 5a of the cathodic lead terminal 3 is bent and placed on the bottom face 7c of the transfer-molded synthetic resin body or sheath 7.

The square box-shape chip-type solid electrolytic capacitor according to the present invention can be modified in various forms in a scope of the principle of the present invention.

For example, as shown in FIG. 2, the parting line 9 having a step portion formed between the leading out faces of the anodic lead terminal 3 and the cathodic lead terminal 5 is composed of the two horizontal planes a-a′ and b-b′, and other vertical plane c-c′ connecting these horizontal planes. It is possible that the parting line 9 becomes a plane inclined at an angle of 1 to 90 degree, which plane connecting two horizontal planes a-a′ and b-b′.

Next, a concrete embodiment of the square box-shape chip-type slid electrolytic capacitor according to the present invention will be explained with reference to the accompanying drawings.

As shown in FIG. 2, by means of using a tantalum solid electrolytic capacitor having an size of length; 2.0 mm, width; 1.25 mm, and height; 1.2 mm, a square box-shape chip-type solid electrolytic capacitor containing a capacitor element 1 of a size of length; 0.93, width; 0.9 mm, and height; 0.6 mm is provided.

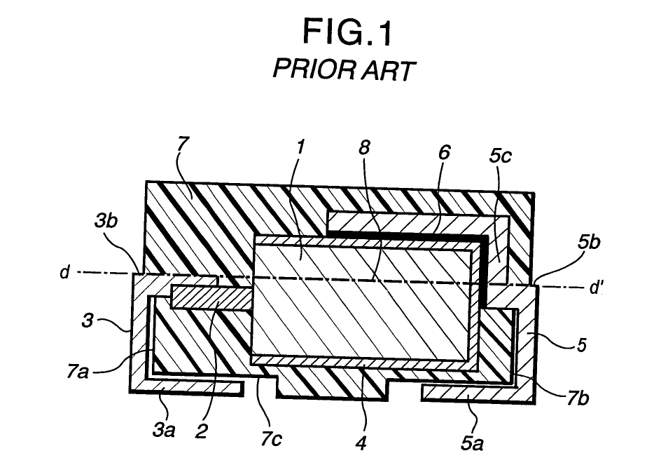

According to the structure of the conventional square box-shape chip-type solid electrolytic capacitor shown in FIG. 1, a tantalum solid electrolytic capacitor having the same size cannot contain a capacitor element 1 larger than that of a size of length; 0.75 mm, width; 0.9 mm, and height; 0.6 mm.

In accordance with the embodiment of the present invention, it is possible advantageously to contain a capacitor element 1 of a size of a length larger than that of the conventional capacitor element by 1.25 time, which element being employed in the chip-type solid electrolytic capacitor. That is, it is possible to improve a volume efficiency of the capacitor element 1 to be placed in the square box-shape chip-type solid electrolytic capacitor by about 25%.

In addition, it is possible to improve or thin the thickness of the transfer-molded synthetic resin body or sheath 7 containing or covering the anodic lead terminal 3 and the cathodic lead terminal 5, and strengthen a mechanical strength of the transfer-molded synthetic resin body or sheath 7 and lead terminals contained therein.

What is claimed is:

1. In a square box-shape ship-type solid electrolytic capacitor provided with a capacitor element having an anodic lead terminal and a cathodic lead terminal, respectively connected to the capacitor element, wherein protruded portions of these lead terminals being bent and running along or on wall faces of a transfer-molded synthetic resin body or sheath;
a square box-shape chip-type solid electrolytic capacitor characterized with that the faces of said protruded portions of said anodic lead terminal and cathodic lead terminal, said protruded portions protrude out of said transfer-molded synthetic resin body or sheath, fail to be placed on the same plane and have a difference in height between said faces of the protruded portions.

2. The square box-shape chip-type solid electrolytic capacitor according to claim 1, wherein the protruded portions of said anodic lead terminal and said cathodic lead terminal, which protruded portions protruding from the transfer-molded synthetic resin body or sheath, respectively has vertical lengths differed from each other.

3. The square box-shape chip-type solid electrolytic capacitor according to claim 2, wherein the cathodic lead terminal is provided with a protruded portion having a vertical length longer than that of the protruded portion of said anodic lead terminal.
